(19) United States
(12) Patent Application Publication
(10) Pub. No.: US 2006/0034980 A1
(43) Pub. Date: Feb. 16, 2006

(54) Packaged pasteurized fresh fruits and a method for production

(76) Inventor: Richard R. Perdue, Taylors, SC (US)

Correspondence Address: MCNAIR LAW FIRM, PA, P.O. BOX 10827, GREENVILLE, SC, 29603-0827, US

(21) Appl. No.: 10/915,671

(22) Filed: Aug. 10, 2004

(51) Int. Cl. A23L 3/00

(52) U.S. Cl. 426/234

(57) ABSTRACT

Pasteurizing fresh fruit comprising the steps of slicing whole fresh fruit; treating the fruit slices with an antioxidant; packing the fruit slices into a container suitable for microwaving; vacuum sealing the fruit slices in the container; microwaving the container after vacuum sealing to raise the temperature of the fruit slices; bathing the container with the fruit slices in a hot water bath following microwaving for a period sufficient to inhibit enzymatic activity and eliminated microbial contamination in the fresh fruit; and, bathing the container with the fruit slices in a cold water bath following bathing in the hot water bath to stabilize the fruit slices for storage; whereby the sliced and treated fruit is pasteurized and retained in a fresh condition within the container for an extended period of time without changes in color, texture and flavor to the fruit, and without the use of artificial preservatives.

### FIELD OF THE INVENTION

The present invention relates to pasteurization, and more particularly to rapid low temperature pasteurization of fresh fruits without changes in color, texture and flavor to the fruit, and without the use of artificial preservatives to provide extended shelf-life.

### BACKGROUND OF THE INVENTION

Prepackaged fruits are a very popular item in grocery stores. The packaging of pre-sliced fresh fruit in sealed pasteurized packages which retain the freshness of the fruit is very attractive to consumers who wish to have fresh fruit flavor, color and texture without having to constantly purchase and slice fresh fruits. Several methods and techniques have been developed in attempts to provide consumers with prepackaged fresh tasting fruit, however, they fail to provide the texture and flavor of truly fresh fruit for a variety of reasons. The majority of the processes used fail due to the use of a high temperature for pasteurizing the fruit. High temperature pasteurization results in significant flavor, texture, and color change. Further, many of the processes fail to provide a truly fresh looking and tasting fruit due to the use of harsh chemical additives such as artificial preservatives and sugars that alter the taste, texture, and color of the fruit in order to obtain a longer shelf-life. The most common option available to consumers searching for prepackaged fruit is the option of purchasing either canned fruit or frozen fruit. The fruit in each of these packages is often highly processed and may contain a great deal of artificial additives that affect that color, taste and texture of the fruit, which is not attractive to consumers looking for the freshest and safest packaged fruit product.

Typically, a consumer who wishes to eat the freshest tasting fruit must purchase fresh fruit and then go through the process of prepare the fruit by cleaning it and slicing it for consumption. While the consumer receives the fresh fruit taste this way and can generally be confident that they are not ingesting any added chemical preservatives; it is time consuming to constantly shop and then prepare the fresh fruit for consumption. Alternatively, some prepackaged sliced fruit products can be found in stores. However, as these are typically fresh fruits which have simply been sliced at the store, the shelf-life of these produces is very limited, and no steps are taken to pasteurize the fruit which control enzymatic activity that decays the fruit, as well as prevents microbial growth that can cause rapid deterioration of the fruit and render it inedible. Other prepackaged sliced fruits are heavily processed with artificial preservatives, which presents an unattractive obstacle to health conscious consumers. Therefore, customers wishing for the taste and quality of fresh fruit, while desiring the convenience of prepackaged fruit do not have a good option for purchasing fruit.

Several attempts at pasteurizing fruit and prepackaging that fruit have been made. These attempts often use high temperature pasteurization which results in a loss of flavor and texture in the fruit. Losing flavor and texture in the fruit essentially negates the ability to claim fresh fruit taste as that is no longer the case with these prepackaged fruits. Other attempts have used preservatives and additives to maintain fruit in a prepackaged environment. The use of additives also changes the flavor of fruit and are considered by many consumers as unhealthy. The more advanced systems created to prepackage fresh fruit require cost prohibitive machinery for prepackaging the fruit, and require a great deal of time to produce the prepackaged fruit. The time required strips the fruit of its freshness, both in texture, color, and flavor.

For example, U.S. Pat. No. 6,010,727 to Rosenthal discloses an actinic process for cold pasteurization of fresh foods and beverages. This process uses ultraviolet light and radiation to pasteurize fresh foods prior to storage. This process is not advantageous as it causes fruit to lose its flavor due to the ultraviolet radiation. The process disclosed in the patent claims to use an additional step that restores texture and flavor to the fruits. It would be far more advantageous to retain the original texture and flavor of the fruits when they were fresh than attempt to recreate that same flavor and texture by additional processing of the fruit. Further, the use of the ultraviolet lights is cost prohibitive and not available for the average food producer.

U.S. Pat. No. 3,961,569 to Kenyon, et al discloses an apparatus for continuous microwave sterilization of food in pouches, including fruit. However, as in other attempts to process and prepackage food, this system uses extremely high temperatures that require the use of a pressurized tunnel to prevent steam from the food from bursting the packages when heated. This high temperature takes away the flavor, color and moisture from the fruit and thus, is not a suitable solution for producing fresh tasting fruit in prepackaged containers. Further, the need for the pressurized tunnel and the overall system is again cost prohibitive and would not allow a small grower of fruits to be able to prepackage their fruits in a pasteurized manner with this method.

Therefore, it is an object of this invention to provide a method for rapid low temperature pasteurization of fresh fruit to preserve the flavor, color and texture of the fruit.

It is a further object of the invention to provide a low cost method of preparing and packaging fresh fruit.

It is a further object of the invention to provide a method of preparing and packaging fresh fruit without the use of artificial chemical preservatives.

### SUMMARY OF THE INVENTION

The above objectives are accomplished according to the present invention by providing a method for pasteurizing sliced fresh fruit that preserves the fresh color, flavor, and texture of the fruit without artificial preservatives. The method includes cutting whole fresh fruit into fruit slices for packaging. The fresh fruit slices are then treated with an antioxidant so that each slice of fruit is coated with the antioxidant. The fresh fruit slices are packed into a high gas barrier package that is microwave permeable. The package is then vacuum sealed to eliminate aerobically sustained contaminants. Once sealed, the fresh fruit slices are arranged in the package to provide a generally uniform package thickness.

Next, the package with the fresh fruit slices is microwaved to raise the temperature of the fresh fruit slices. The package is then bathed in a hot water bath to inhibit enzymatic activity and eliminated microbial contamination. Next, the package is bathed in a cold water bath to lower the temperature of the fruit and stop the pasteurization process. Finally, the package is stored at a temperature range of preferably between 28° F. to 38° F.

Alternatively, the fresh fruit slices may be microwaved prior to packaging in the package. In this embodiment, the fruit slices are packaged into the package after microwaving using a pressure stuffing system that displaces all air from the package with the fresh fruit slices and seals the package in an airtight manner with no air gaps in the package, as vacuum packaging a hot product is typically disastrous due to rapid boiling of any liquid.

Further, using the above method, a pasteurized fresh fruit packaged product can be produced that comprises fresh fruit sliced and treated with an antioxidant and a vacuum sealed plastic package maintaining a high gas barrier until broken. The sliced and treated fresh fruit are positioned within the package to provide a uniform thickness. The vacuum sealed plastic package containing the sliced and treated fresh fruit is subjected to microwaving, being submerged in a hot water bath, being submerged in a cold water bath, and finally, subjected to being stored at a temperature range of between 28° F. to 38° F. As a result, the sliced and treated fresh fruit is pasteurized and retained in a fresh condition within the package for an extended period of time without changes in color, texture and flavor to the fruit, and without the use of artificial preservatives.

### BRIEF DESCRIPTION OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIGS. 1A, 1B, and 1C illustrate the method for preparing fruit according to the present invention; and,

FIG. 2 shows an alternative embodiment for pasteurizing and packaging fresh fruit slices according to the present invention.

### DETAILED DESCRIPTION OF A PREFERRED EMBODIMENT

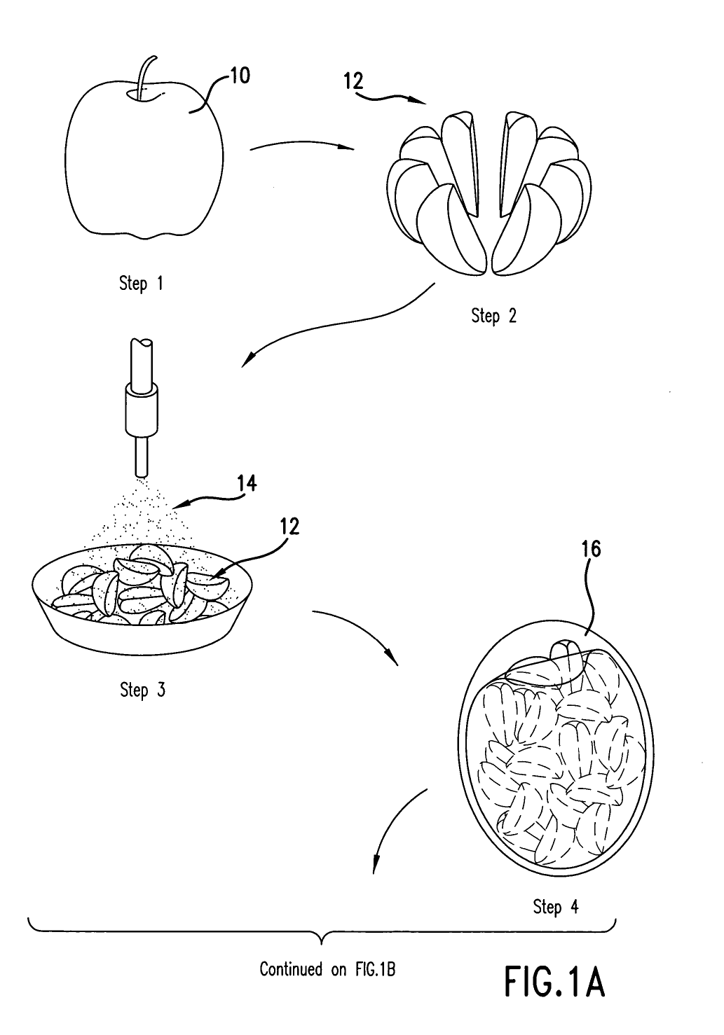

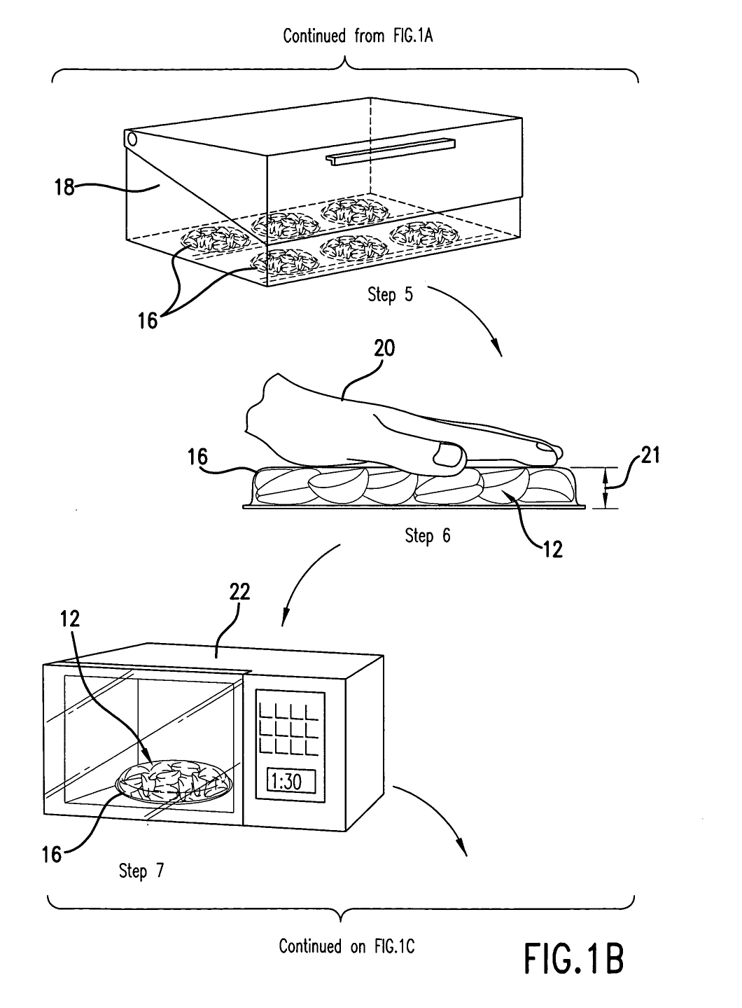

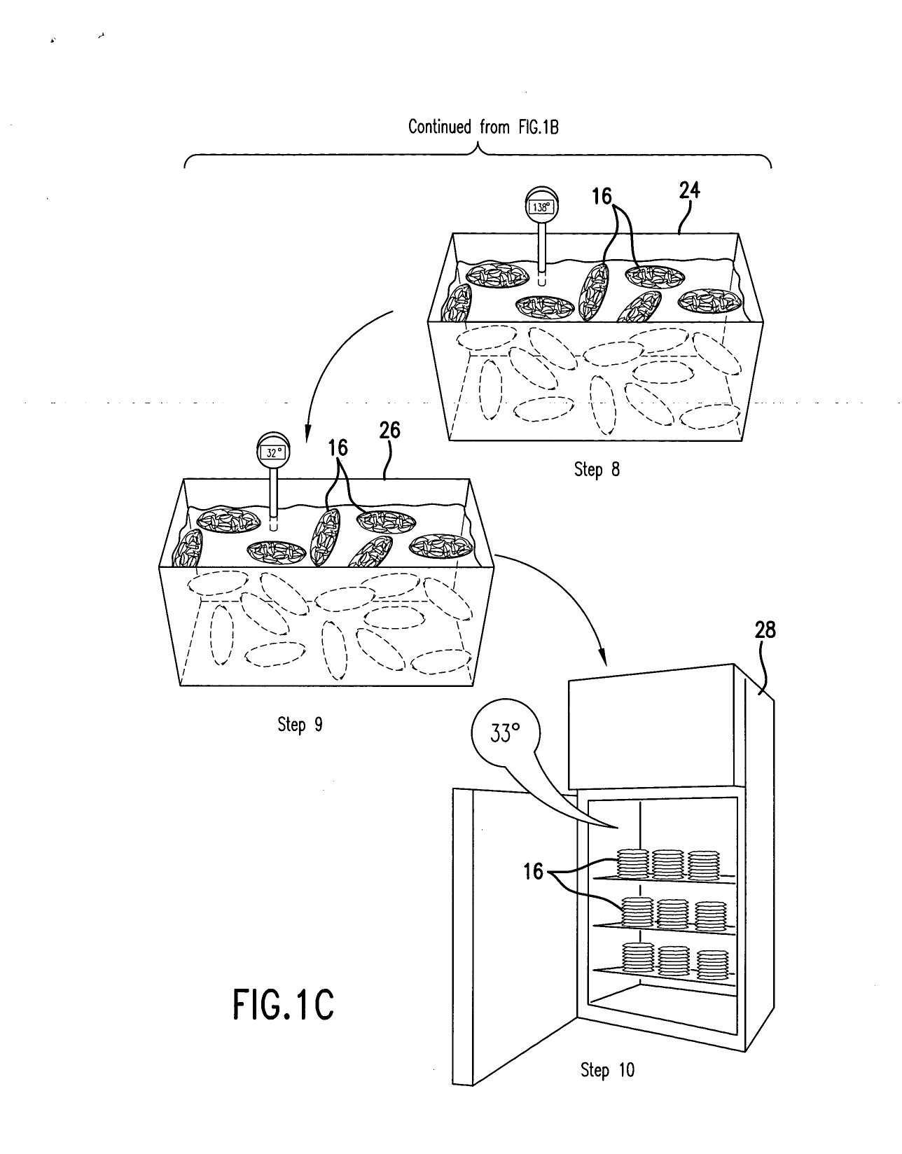

With reference to the drawings, the invention will now be described in more detail. Referring to FIG. 1A, at step 1, fresh fruit is provided for processing. As illustrated, the fresh fruit provided for processing is an apple 10, which is for illustrative purposes only for explaining the pasteurization process, and the process is not limited strictly to apples, but rather any fruit. In step 2 of FIG. 1A, the method includes cutting whole fresh fruit into fruit slices for packaging. Accordingly, apple 10 is sliced into various segments designated generally by reference number 12. Preferably, as shown in step 2, apple 10 has been peeled and cored in addition to slicing to remove skin and seeds from the fruit prior to packaging.

Moving to step 3 of FIG. 1A, apple slices 12 are treated with an antioxidant, designated generally as 14, so that each slice of fruit is coated with the antioxidant. Preferably, apple slices 12 are treated with an antioxidant selected from the group consisting of citric acid and ascorbic acid, which are naturally found in the fruits and avoids the use of harsh artificial chemical preservatives. Alternatively, the sliced fruit, in this case apples, may be treated with the salt of an acid, such as ascorbic acid salt.

As shown in step 4 of FIG. 1A, apple slices 12 are packaged. In the preferred embodiment, the fruit slices are packed into a high gas barrier flexible plastic package 16 that is microwave permeable. However a semi-rigid or rigid package may alternatively be utilized.

Referring now to FIG. 1B, once package 16 is filled with apple slices 12, it is placed in a vacuum chamber 18 and chamber vacuumized to remove air in the package surrounding apple slices 12. Package 16 is heat sealed in chamber 18 to vacuum package the fresh apple slices in the package. Chamber vacuumizing and heat sealing is well known by those skilled in the art and is represented schematically in step 5 of FIG. 1B to generally show this portion of the process. It is preferred that the fruit slices are chilled prior to cutting and vacuumizing, which creates a better vacuum. Vaccuum sealing the packages of fruit prevents the growth of mold and other aerobically sustained contaminants.

In step 6 of FIG. 1B, apple slices 12 are arranged in package 16 following vacuum packaging to provide a generally uniform package thickness. In the preferred embodiment, the thickness of package 16 is generally about one inch, designated generally as 21. Preferably, the uniform thickness does not exceed 1.5 inches, as additional heating time or higher temperatures would be required, which would alter the flavor, color and texture of the fresh fruit. The apple slices may be arranged by hand, designated by reference number 20, by simply pushing them around inside the bag. Alternatively, this may also be accomplished by mechanical means that flattens the package, which however, can damage the fruit. Accordingly, it is preferred that the apple slices be manually manipulated within the package.

Next, referring to step 7 of FIG. 1B, package 16 with arranged apple slices 12 is placed in microwave 22 and microwaved to raise the temperature of the fresh fruit slices to approximately 135° F. Preferably, the fresh fruit slices, in this case apple slices, are microwaved in package 16 for approximately 1.5 minutes to obtain a temperature of approximately 135° F. Most notably, the temperature of the fresh fruit slices during microwaving should not exceeding 150° F. or changes in flavor, color and texture can occur.

Referring to step 8 in FIG. 1C, following microwaving, package 16 is bathed in a hot water bath 24 having a temperature range of approximately 135° F. to 150° F. This is done to inhibit enzymatic activity and eliminated microbial contamination in the fruit slices. Preferably, package 16 is allowed to dwell in hot water bath 24 for approximately 10 minutes, but generally not more than 15 minutes. In a particularly preferred embodiment, hot water bath 24 has a temperature of 138° F. which is hot enough to kill yeast and bacteria microbes, but not so hot that the texture of the fruit is changed. Heating of the package in the microwave is done to quickly raise the temperature. Continued microwaving would overheat the package and ruin the taste, texture, and color of the fruit. Accordingly, once the temperature is quickly raided to approximately 135° F., the hot water bath is used to maintain the elevated temperature of the package for a sufficient time to inhibit enzymatic activity and eliminated microbial contamination, which is approximately 10 minutes. The temperature of 138° F. for the hot water bath is ideal to prevent damage to the flavor, texture and color of the fruit while providing the necessary pasteurizing effects. While some fruits are better able to handle higher temperatures, a hot water bath over approximately 150° F. will typically produce unacceptable fruit as an end product.

Following bathing in the hot water bath, as shown in step 9 of FIG. 1C, package 16 is immediately bathed in a cold water bath 26 to stop the pasteurization process by lowering the temperature of the fruit, thereby preventing chemical changes to the fresh fruit slices from exposure to the hot water bath. Preferably, package 16 is bathed in the cold water bath for approximately 1 hour to stabilize apple slices 12 for storage. In the preferred embodiment, cold water bath 26 is a chilled water bath of approximately 32° F. However, with a sufficient dwell time, even a cold tap water bath with a temperature as high as approximately 60° F may be used.

Finally, referring to step 10 of FIG. 1C, after cooling packages 16 in cold water bath 26, the packages are stored in a refrigerator 28 at a temperature range of between 28° F. to 38° F. Preferably, the packages are stored at 33° F. to prevent freezing.

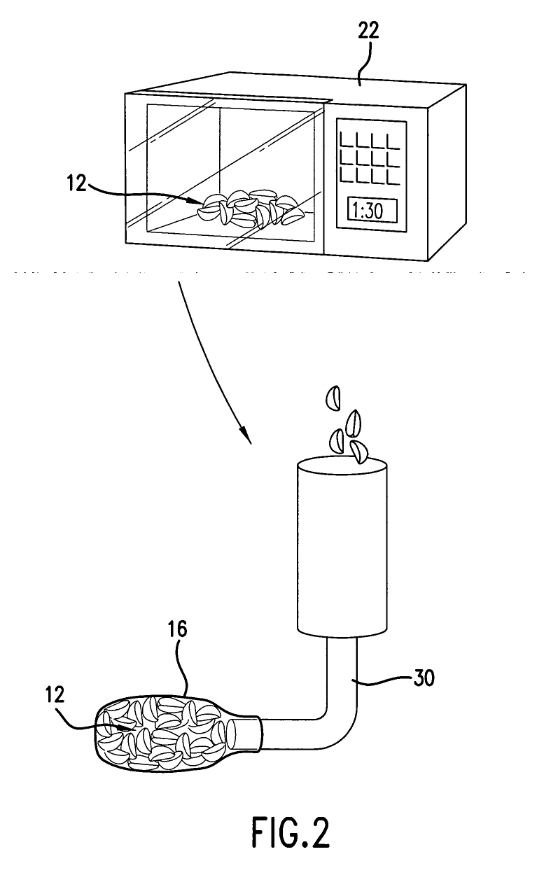

Alternatively, Referring to FIG. 2, apple slices 12 may be microwaved in microwave 22 for approximately 1.5 minutes prior to packaging to raise the temperature of the fruit slices to approximately 135° F., but not exceeding 150° F. In this alternative embodiment, apple slices 12 are packaged into the package after microwaving using a pressure stuffing system, designated generally by reference number 30, that displaces all air from the package with the fresh fruit slices and seals the package in an airtight manner with no air gaps in the package. Because the apple slices are hot and contain liquid, they cannot be vacuum sealed using the method described above as vacuum packaging a hot product is typically disastrous due to rapid boiling of any liquid, which causes the package to burst. Accordingly, a pressure stuffing system well known by those skilled in the art is an acceptable alternative which eliminates the need to manipulate the apples within the package. Following pressure stuffing, the packages are then bathed in hot and cold water and stored as described above.

While a preferred embodiment of the invention has been described using specific terms, such description is for illustrative purposes only, and it is to be understood that changes and variations may be made without departing from the spirit or scope of the following claims.

What is claimed is:

1. A method for pasteurizing sliced fresh fruit while preserving the fresh color, flavor, and texture of the fruit comprising the steps of:
cutting whole fresh fruit into fruit slices for packaging;
treating said fresh fruit slices with an antioxidant;
packing said fresh fruit slices into a high gas barrier package that is microwave permeable;
chamber vacuumizing said package to remove air in the package surrounding the fruit slices;
sealing said package in said chamber to vacuum package said fresh fruit slices in said package;
arranging said fruit in said package following vacuum packaging of said fresh fruit slices to provide a generally uniform package thickness;
microwaving said package to raise the temperature of said fresh fruit slices to approximately 135° F.;
bathing said package in a hot water bath having a temperature range of approximately 135° F. to 150° F. following microwaving to inhibit enzymatic activity and eliminated microbial contamination;
bathing said package in a cold water bath following bathing in said hot water bath to stabilize said fresh fruit for storage; and,
storing said package at a temperature range of between 28° F. to 38° F.

2. The method of claim 1 wherein said whole fresh fruit is chilled, peeled and cored to remove skin and seeds from the fruit.

3. The method of claim 1 wherein said antioxidant is selected from the group consisting of acid and acid salts.

4. The method of claim 1 wherein said package is heat sealed to maintain said vacuum within said package.

5. The method of claim 1 wherein said uniform thickness of said fresh fruit slices arranged in said package does not exceed approximately 1.5 inches.

6. The method of claim 1 wherein said fresh fruit slices are mircowaved in said package for approximately 1.5 minutes to obtain said temperature of approximately 135° F.

7. The method of claim 6 wherein the temperature of said fresh fruit slices during microwaving does not exceeding 150° F.

8. The method of claim 1 wherein said package is bathed in said hot water bath for approximately 10 minutes.

9. The method of claim 1 wherein said package is bathed in said cold water bath for approximately 1 hour.

10. The method of claim 1 wherein said fresh fruit slices are microwaved prior to packaging in said package for approximately 1.5 minutes to raise the temperature of said fruit slices to approximately 135° F., but not exceeding 150° F.

11. The method of claim 10 wherein said fruit slices are packaged into said package after microwaving using a pressure stuffing system that displaces all air from said package with said fresh fruit slices and seals the package in an airtight manner with no air gaps in said package.

12. A packaged pasteurized fresh fruit product produced by the method of claim 1.

13. A pasteurized fresh fruit packaged product comprising:
fresh fruit sliced and treated with an antioxidant;
a vacuum sealed plastic package maintaining a high gas barrier until broken;
said sliced and treated fresh fruit positioned within said package to provide a uniform thickness; and,
said vacuum sealed plastic package containing said sliced and treated fresh fruit being subjected to microwaving to raise the temperature of said fresh fruit slices to approximately 135° F., submerging in a hot water bath of approximately 138° F. to inhibit enzymatic activity and eliminated microbial contamination, submerging in a cold water bath to prevent chemical changes to the fresh fruit slices caused by exposure to said hot water bath, and storing at a temperature range of between 28° F. to 38° F.;
whereby said sliced and treated fresh fruit is pasteurized and retained in a fresh condition within said package for an extended period of time without changes in color, texture and flavor to the fruit, and without the use of artificial preservatives.

14. The product of claim 13 wherein said fruit slices are treated with acid selected from the group consisting of citric acid and ascorbic acid.

15. The product of claim 13 wherein said fruit slices are treated with an acid salt.

16. The product of claim 13 wherein said fresh fruit slices are subjected to mircowaving in said package for approximately 1.5 minutes to obtain said temperature of approximately 135° F.

17. The product of claim 13 wherein said package is subjected to said hot water bath for approximately 10 minutes.

18. The product of claim 13 wherein said package is subjected to said cold water bath for approximately 1 hour.

19. A method for pasteurizing sliced fresh fruit while preserving the fresh color, flavor, and texture of the fruit comprising the steps of:
slicing whole fresh fruit;
treating said fresh fruit slices with an antioxidant;
packing said fresh fruit slices into a container suitable for microwaving;
vacuum sealing said fresh fruit slices in said container;
microwaving said container after vacuum sealing to raise the temperature of said fresh fruit slices;
bathing said container with said fresh fruit in a hot water bath following microwaving for a period sufficient to inhibit enzymatic activity and eliminated microbial contamination in said fresh fruit; and,
bathing said container with said fresh fruit in a cold water bath following bathing in said hot water bath to stabilize said fresh fruit for storage;
whereby the sliced and treated fresh fruit is pasteurized and retained in a fresh condition within said container for an extended period of time without changes in color, texture and flavor to the fruit, and without the use of artificial preservatives.

20. The method of claim 19 wherein said fruit slices are treated with an antioxidant selected from the group consisting of citric acid, ascorbic acid, and salt of ascorbic acid.

21. The method of claim 19 wherein said fresh fruit slices are mircowaved in said container for approximately 1.5 minutes to obtain a temperature of approximately 135° F.

22. The method of claim 19 wherein said fresh fruit slices are arranging in said container to provide a generally uniform package thickness no greater than approximately 1.5 inches.

23. The method of claim 19 wherein said containers are stored at a temperature range of between 28° F. to 38° F. following said cold water bath.
